(19) United States
(12) Patent Application Publication
(10) Pub. No.: US 2011/0134328 A1
(43) Pub. Date: Jun. 9, 2011

(54) VIDEO PROCESSING APPARATUS AND VIDEO PROCESSING METHOD

(75) Inventors: Shinichi TOMIOKA, Osaka (JP); Nobuko Fujita, Osaka (JP)

(73) Assignee: Panasonic Corporation, Osaka (JP)

(21) Appl. No.: 13/025,626

(22) Filed: Feb. 11, 2011

Related U.S. Application Data
(63) Continuation of application No. PCT/JP2009/003277, filed on Jul. 13, 2009.

(30) Foreign Application Priority Data
Nov. 27, 2008 (JP) 2008-303002

(51) Int. Cl. H04N 9/64

(52) U.S. Cl. 348/652; 348/E09.037

(57) ABSTRACT

A video processing apparatus includes: a skin color region detection device that detects a skin color region in one frame from hue/saturation/brightness signals; a skin color area calculation device that calculates the skin color area of one frame based on the skin color region detection result; a gamma correction control device that generates a gamma correction control signal for a luminance signal based on the skin color area calculation result; a gamma correction device that performs gamma correction according to the gamma correction control signal for the luminance signal; a color space transform device that transforms the gamma-corrected luminance signal and color-difference signals to the hue/saturation/brightness signals; a skin color correction device that corrects only the skin color based on the transformed signals; a color space inverse transform device that inverse-transforms the corrected hue/saturation/brightness signals to color signals; and a video display device that displays the color signals as video.

### CROSS-REFERENCE TO RELATED APPLICATION

This is a continuation of PCT International Application PCT/JP2009/003277 filed on Jul. 13, 2009, which claims priority to Japanese Patent Application No. 2008-303002 filed on Nov. 27, 2008. The disclosures of these applications including the specifications, the drawings, and the claims are hereby incorporated by reference in their entirety.

### BACKGROUND

The present disclosure relates to a video processing apparatus and video processing method that stretch a dark image portion further to the black side, to present a dynamic image free from “black floating,” and improve color reproducibility of the skin color.

In recent years, the screen size of flat panel TVs has been remarkably increasing, and with this increase in size, requests for higher image quality have been increasingly growing. In particular, since human eyes are sensitive to reproduction of human skin, the reproducibility of human skin greatly affects the image quality.

A video signal correction control apparatus according to a conventional technique includes: a skin color area detection circuit that calculates the area of a skin color portion of one frame from color-difference signals; a skin color average luminance level detection circuit that detects the average luminance level of the skin color portion of one frame from the color-difference signals and a luminance signal; an average luminance level detection circuit that detects the average luminance level of one frame from the luminance signal; a black stretch correction control device that prepares a black stretch correction control signal based on the output of the skin color area detection circuit, the output of the skin color average luminance level detection circuit, and the output of the average luminance level detection circuit; and a black stretch correction circuit that performs black stretch correction for the luminance signal based on the output of the black stretch correction control device (see Japanese Patent Publication No. H07-288839).

### SUMMARY

In the conventional technique described above, since the skin color area is calculated from only the color-difference signals, not only the area of the human skin but also the area of any other object having a color close to the skin color are calculated as the skin color area. This technique therefore has a problem that the black stretch effect decreases in a specific landscape.

The first video processing apparatus of the present invention includes: a skin color region detection device configured to detect a skin color region in one frame from hue, saturation, and brightness signals; a skin color area calculation device configured to calculate the area of a skin color portion of one frame based on the skin color region detection result; a gamma correction control device configured to generate a gamma correction control signal for a luminance signal based on the output of the skin color area calculation device; a gamma correction device configured to perform gamma correction according to the gamma correction control signal for the luminance signal as input data based on the output of the gamma correction control device; a color space transform device configured to transform the gamma-corrected luminance signal and color-difference signals to the hue, saturation, and brightness signals; a skin color correction device configured to correct only the skin color based on the outputs of the skin color region detection device and the color space transform device; a color space inverse transform device configured to transform the corrected hue, saturation, and brightness signals output from the skin color correction device to color signals as output data; and a video display device configured to display the color signals as an image.

The second video processing apparatus of the present invention includes: a color space transform device configured to transform color signals as input data to hue, saturation, and brightness signals; a skin color region detection device configured to detect a skin color region in one frame from the hue, saturation, and brightness signals output from the color space transform device; a skin color correction device configured to correct only the skin color based on the hue, saturation, and brightness signals output from the color space transform device and the output of the skin color region detection device; a gamma correction control device configured to generate a gamma correction control signal based on the output of the skin color region detection device; a gamma correction device configured to perform gamma correction according to the gamma correction control signal for only the brightness signal output from the skin color correction device based on the output of the gamma correction control device; a color space inverse transform device configured to transform the gamma-corrected brightness signal and the hue and saturation signals output from the skin color correction device to color signals as output data; and a video display device configured to display the color signals as an image.

The third video processing apparatus of the present invention includes: a color space transform device configured to transform color signals as input data to hue, saturation, and brightness signals; a skin color region detection device configured to detect a skin color region in one frame from the hue, saturation, and brightness signals output from the color space transform device; an object recognition device configured to recognize the shape of a human based on the output of the skin color region detection device; a skin color correction device configured to correct only the skin color based on the hue, saturation, and brightness signals output from the color space transform device and the output of the object recognition device; a gamma correction control device configured to generate a gamma correction control signal based on the output of the object recognition device; a gamma correction device configured to perform gamma correction according to the gamma correction control signal for only the brightness signal output from the skin color correction device based on the output of the gamma correction control device; a color space inverse transform device configured to transform the gamma-corrected brightness signal and the hue and saturation signals output from the skin color correction device to color signals as output data; and a video display device configured to display the color signals as an image.

The skin color region detection device may include: a hue-based skin color detector configured to detect the skin color based on only hue; a saturation-based skin color detector configured to detect the skin color based on only saturation; a brightness-based skin color detector configured to detect the skin color based on only brightness; and a skin color region determiner configured to determine the skin color region based on the outputs of the hue-based, saturation-based, and brightness-based skin color detectors.

The video processing method of the present invention is a method corresponding to any of the first to third video processing apparatuses of the present invention described above.

In the video processing apparatus and video processing method of the present invention, the detection precision of the skin color region can be improved in the color space comprised of hue, saturation, and brightness. Thus, the problem that the effect of deepening black is reduced in a specific landscape is overcome, permitting improvement in the reproducibility of black and skin colors. Also, since a plurality of circuit blocks share the detection signal indicating the region of human skin, the circuit scale of the video processing apparatus can be reduced. Moreover, since only the human skin color can be corrected, the reproducibility of the skin color can be improved.

### BRIEF DESCRIPTION OF THE DRAWINGS

FIG. 1 is a block diagram showing a video processing apparatus of the first embodiment of the present invention.

FIG. 2 is a view showing the operation of a gamma correction device in the first embodiment.

FIG. 3 is a block diagram showing details of a skin color region detection device in the first embodiment.

FIG. 4 is a view showing skin color detection in a hue range in the first embodiment.

FIG. 5 is a view showing skin color detection in a saturation range in the first embodiment.

FIG. 6 is a view showing skin color detection in a brightness range in the first embodiment.

FIG. 7 is a view showing gamma correction associated with the skin color area in the first embodiment.

FIG. 8 is a block diagram showing a video processing apparatus of the second embodiment of the present invention.

FIG. 9 is a block diagram showing a video processing apparatus of the third embodiment of the present invention.

### DETAILED DESCRIPTION

Embodiments of the present invention will be described hereinafter with reference to the drawings.

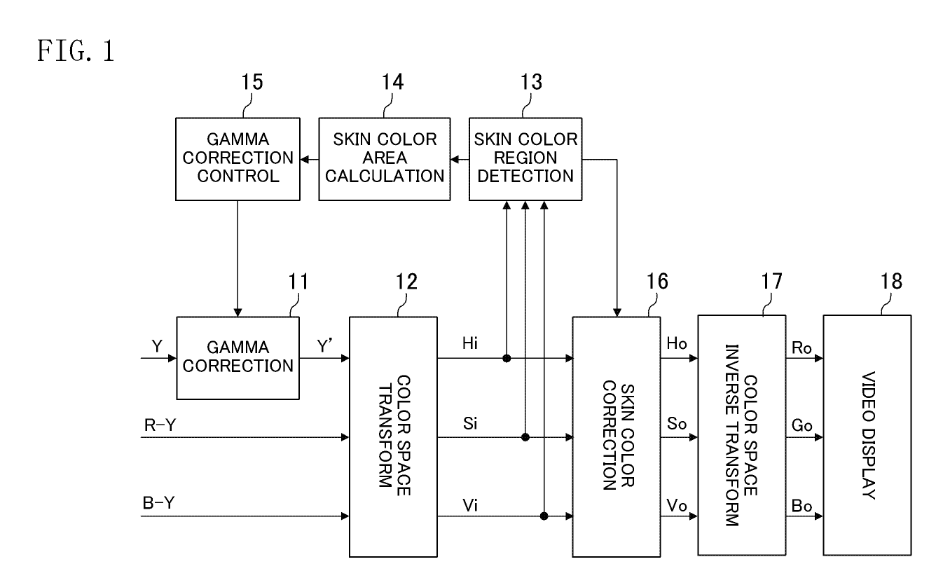

A video processing apparatus of the first embodiment will be described with reference to FIGS. 1-7. In the first embodiment, in the color space comprised of hue, saturation, and brightness, a skin color region is detected, the area of the skin color region in one frame is calculated, and gamma correction is performed in which black is deepened by lowering the level of the luminance signal on its low-luminance side, in association with skin color correction. Also, for the gamma-corrected signal, the skin color correction is performed in which only the skin color is subjected to adjustment of hue, saturation, and brightness based on the detection result of the skin color region.

FIG. 1 is a block diagram of the video processing apparatus of the first embodiment. Referring to FIG. 1, the video processing apparatus includes: a gamma correction device 11 that performs gamma correction according to a gamma correction control signal for a luminance signal Y as input data; a color space transform device 12 that transforms a gamma-corrected luminance signal Y′ and color-difference signals R-Y and B-Y as input data to hue Hi, saturation Si, and brightness Vi; a skin color region detection device 13 that detects the skin color region from the hue Hi, the saturation Si, and the brightness Vi; a skin color area calculation device 14 that calculates the skin color area from the skin color region detection result; a gamma correction control device 15 that generates the gamma correction control signal from the calculated skin color area; a skin color correction device 16 that adjusts the skin color having the hue Hi, the saturation Si, and the brightness Vi based on the skin color region detection result; a color space inverse transform device 17 that transforms corrected hue Ho, saturation So, and brightness Vo to color signals Ro, Go, and Bo as output data; and a video display device 18 that displays the color signals Ro, Go, and Bo as an image.

In the configuration shown in FIG. 1, the luminance signal Y as input data is received by the gamma correction device 11, where the signal level of only a low-luminance portion of the luminance signal Y is lowered, to deepen black.

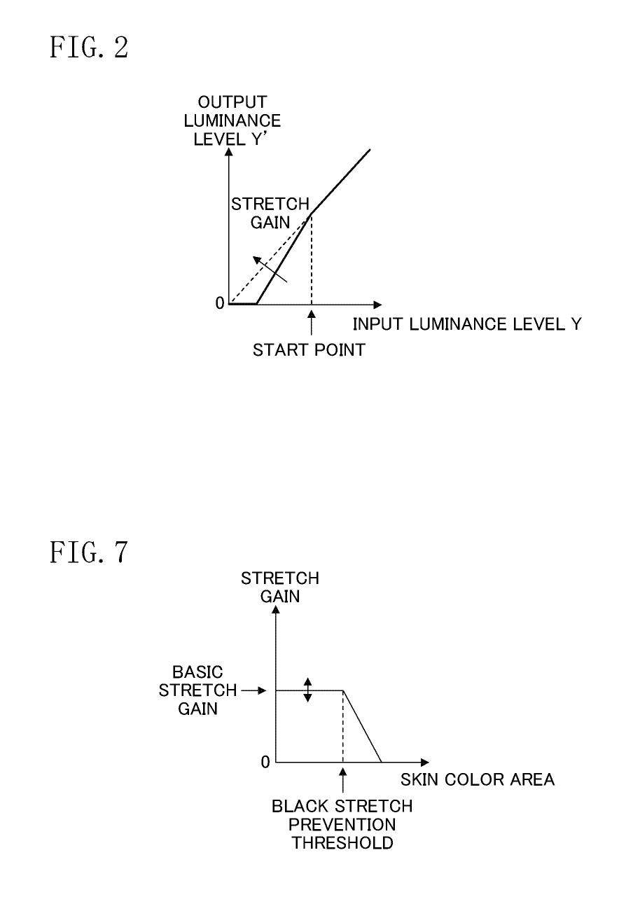

FIG. 2 shows an example of the gamma correction function. Black is deepened by setting a gamma break point (start point) and lowering the level of the luminance signal at and below the break point.

In the color space transform device 12, the gamma-corrected luminance signal Y′ and the color-difference signals R-Y and B-Y as input data are transformed to hue Hi, saturation Si, and brightness Vi, using a known color space transform equation. The transformed hue Hi, saturation Si, and brightness Vi are input into the skin color region detection device 13 and the skin color correction device 16. In the skin color region detection device 13, only a skin color region is detected. From the output result of the skin color region detection device 13, the skin color area calculation device 14 calculates the skin color area.

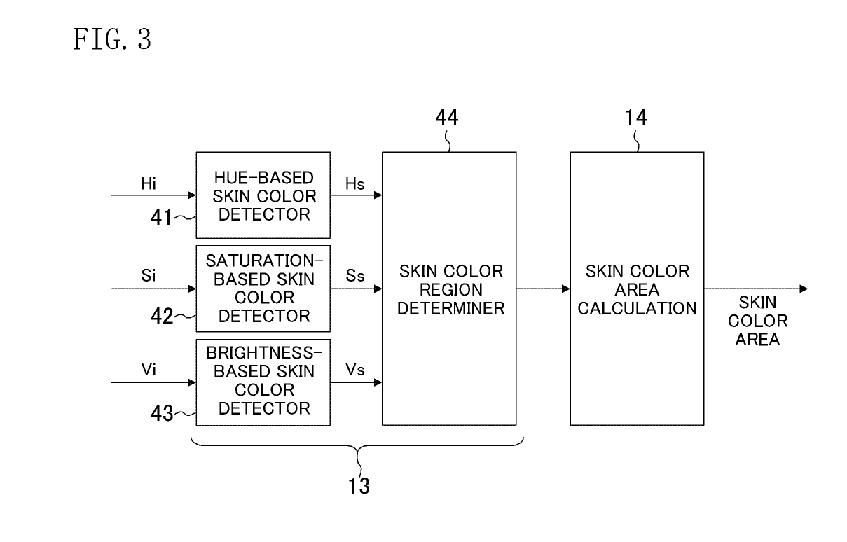

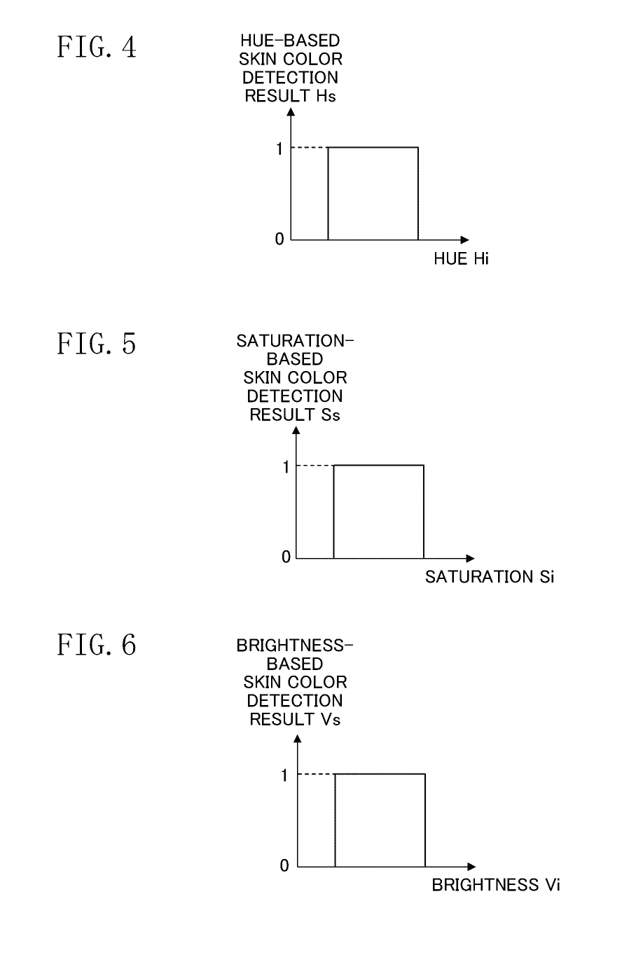

FIG. 3 shows an example of the skin color region detection device 13. A skin color detector 41 detects the skin color region based on the hue. FIG. 4 shows an example of skin color detection in the hue-based skin color detector 41, where the skin color region is detected according to a range of the hue, and is represented by 1 while the other region is represented by 0. A skin color detector 42 detects the skin color region based on the saturation. FIG. 5 shows an example of skin color detection in the saturation-based skin color detector 42, where the skin color region is detected according to a range of the saturation, and is represented by 1 while the other region is represented by 0. A skin color detector 43 detects the skin color region based on the brightness. FIG. 6 shows an example of skin color detection in the brightness-based skin color detector 43, where the skin color region is detected according to a range of the brightness, and is represented by 1 while the other region is represented by 0. A skin color region determiner 44 multiplies the detection results of the skin color detectors 41, 42, and 43 and outputs a signal representing 1 for the skin color region or 0 for the other region. The skin color area calculation device 14 accumulates the output signal of the skin color region determiner 44 for one frame period, thereby to calculate the skin color area. The calculated skin color area is input into the gamma correction control device 15, where the gamma correction amount according to the skin color area is determined.

FIG. 7 shows an example of the gamma correction control function of the gamma correction control device 15. By determining a black stretch prevention threshold and a basic stretch gain, a stretch gain as the gamma correction amount is determined according to the skin color area. The stretch gain is decreased in a range where the skin color area is large.

The hue Hi, saturation Si, and brightness Vi after the gamma correction and the color space transform are input into the skin color correction device 16, and corrected for only the region determined as the skin color region based on the skin color region detection result. For example, the brightness Vi may be multiplied by 1.5 for only the skin color region, to obtain a beautiful skin color. The corrected hue Ho, saturation So, and brightness Vo are inverse-transformed to the color signals Ro, Go, and Bo in the color space inverse transform device 17, using a known color space inverse transform equation. Finally, the inverse-transformed color signals Ro, Go, and Bo are displayed in the video display device 18.

### Second Embodiment

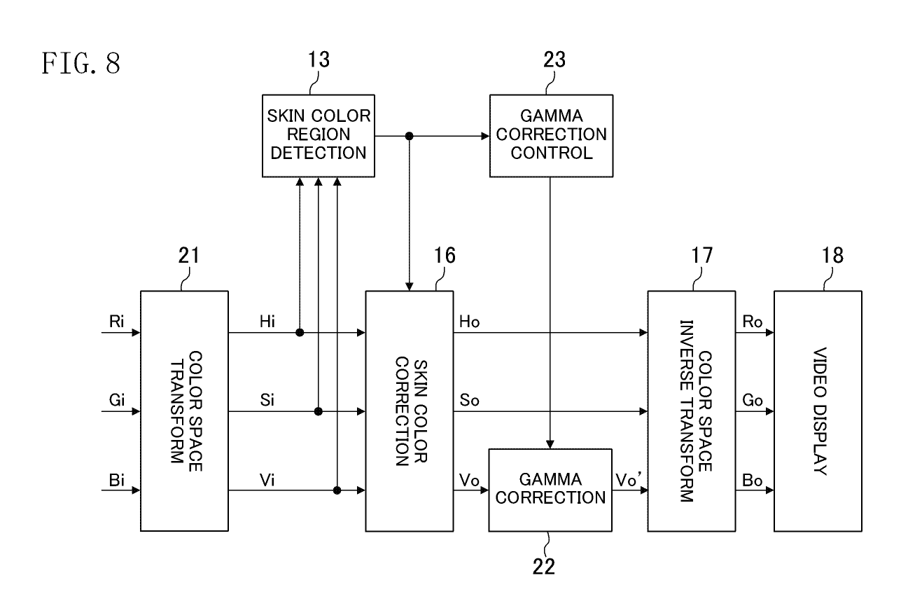

FIG. 8 is a block diagram of a video processing apparatus of the second embodiment. Referring to FIG. 8, the vide processing apparatus includes: a color space transform device 21 that transforms color signals Ri, Gi, and Bi as input data to hue Hi, saturation Si, and brightness Vi; a gamma correction control device 23 that generates a gamma correction control signal from the output of the skin color region detection device 13; and a gamma correction device 22 that performs gamma correction according to the gamma correction control signal for the skin-color corrected brightness signal Vo.

In the configuration shown in FIG. 8, the input color data (signals) Ri, Gi, and Bi are received by the color space transform device 21, where they are transformed to hue Hi, saturation Si, and brightness Vi, using a known color space transform equation from RGB to HSV.

The transformed hue Hi, saturation Si, and brightness Vi are then input into the skin color region detection device 13 and the skin color correction device 16. This operation is similar to that described in the first embodiment. The skin color region detection result is sent to the gamma correction control device 23, which then outputs the gamma correction control signal for suppressing the gamma correction effect in the skin color region.

The skin-color corrected brightness signal Vo is sent to the gamma correction device 22, where gamma correction is performed based on the gamma correction control signal, to obtain a gamma-corrected brightness signal Vo′. The color space inverse transform device 17 inverse-transforms the skin-color corrected hue Ho, saturation So, and brightness Vo′ to the color signals Ro, Go, and Bo as output data. The operation of the video display device 18 is similar to that in the first embodiment.

### Third Embodiment

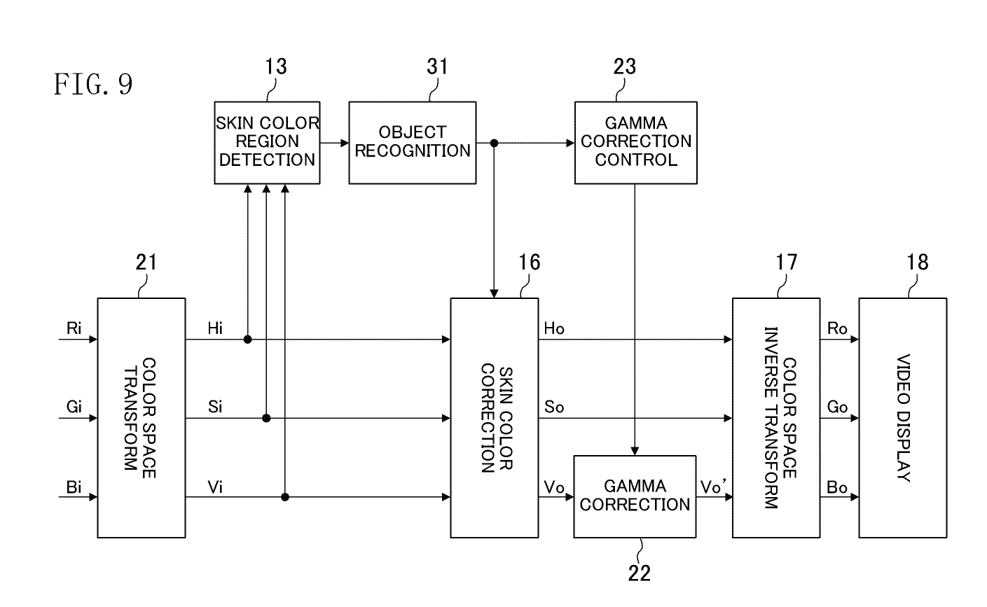

FIG. 9 is a block diagram showing a vide processing apparatus of the third embodiment. Referring to FIG. 9, the vide processing apparatus includes an object recognition device 31 that outputs a signal indicating whether an object is a human by analyzing the shape of the object from the skin color region detection result.

In the configuration shown in FIG. 9, the color space transform device 21 and the skin color region detection device 13 are similar to those in the second embodiment. The skin color region detection result is sent to the object recognition device 31, where the shape of an object is analyzed from the skin color region detection result and generates a signal indicating whether the object is a human. Based on the generated signal, the skin color correction device 16 performs skin color correction for only the human skin color region.

The output of the object recognition device 31 is also sent to the gamma correction control device 23, which then outputs the gamma correction control signal for suppressing the gamma correction effect when the object is a human. The skin-color corrected brightness signal Vo is sent to the gamma correction device 22, where gamma correction is performed based on the gamma correction control signal, to obtain the gamma-corrected brightness signal Vo′. The operations of the color space inverse transform device 17 and the video display device 18 are similar to those in the second embodiment.

The configuration of the skin color region detection device 13 shown in FIG. 3 is also applicable to the second and third embodiments. In the first to third embodiments, the video display device 18 for displaying color data may be a monitor device of an imaging apparatus.

As described above, the video processing apparatus and video processing method of the present invention can improve the detection precision of the skin color region in the color space comprised of hue, saturation, and brightness, and thus are useful as a technique for flat panel TVs, etc.

What is claimed is:

1. A video processing apparatus, comprising:
a skin color region detection device configured to detect a skin color region in one frame from hue, saturation, and brightness signals;
a skin color area calculation device configured to calculate the area of a skin color portion of one frame based on the skin color region detection result;
a gamma correction control device configured to generate a gamma correction control signal for a luminance signal based on the output of the skin color area calculation device;
a gamma correction device configured to perform gamma correction according to the gamma correction control signal for the luminance signal as input data based on the output of the gamma correction control device;
a color space transform device configured to transform the gamma-corrected luminance signal and color-difference signals to the hue, saturation, and brightness signals;
a skin color correction device configured to correct only the skin color based on the outputs of the skin color region detection device and the color space transform device;
a color space inverse transform device configured to transform the corrected hue, saturation, and brightness signals output from the skin color correction device to color signals as output data; and
a video display device configured to display the color signals as an image.

2. The video processing apparatus of claim 1, wherein
the skin color region detection device includes:
a hue-based skin color detector configured to detect the skin color based on only hue;
a saturation-based skin color detector configured to detect the skin color based on only saturation;
a brightness-based skin color detector configured to detect the skin color based on only brightness; and
a skin color region determiner configured to determine the skin color region based on the outputs of the hue-based, saturation-based, and brightness-based skin color detectors.

3. A video processing apparatus comprising:
a color space transform device configured to transform color signals as input data to hue, saturation, and brightness signals;
a skin color region detection device configured to detect a skin color region in one frame from the hue, saturation, and brightness signals output from the color space transform device;
a skin color correction device configured to correct only the skin color based on the hue, saturation, and brightness signals output from the color space transform device and the output of the skin color region detection device;
a gamma correction control device configured to generate a gamma correction control signal based on the output of the skin color region detection device;
a gamma correction device configured to perform gamma correction according to the gamma correction control signal for only the brightness signal output from the skin color correction device based on the output of the gamma correction control device;
a color space inverse transform device configured to transform the gamma-corrected brightness signal and the hue and saturation signals output from the skin color correction device to color signals as output data; and
a video display device configured to display the color signals as an image.

4. The video processing apparatus of claim 3, wherein
the skin color region detection device includes:
a hue-based skin color detector configured to detect the skin color based on only hue;
a saturation-based skin color detector configured to detect the skin color based on only saturation;
a brightness-based skin color detector configured to detect the skin color based on only brightness; and
a skin color region determiner configured to determine the skin color region based on the outputs of the hue-based, saturation-based, and brightness-based skin color detectors.

5. A video processing apparatus comprising:
a color space transform device configured to transform color signals as input data to hue, saturation, and brightness signals;
a skin color region detection device configured to detect a skin color region in one frame from the hue, saturation, and brightness signals output from the color space transform device;
an object recognition device configured to recognize the shape of a human based on the output of the skin color region detection device;
a skin color correction device configured to correct only the skin color based on the hue, saturation, and brightness signals output from the color space transform device and the output of the object recognition device;
a gamma correction control device configured to generate a gamma correction control signal based on the output of the object recognition device;
a gamma correction device configured to perform gamma correction according to the gamma correction control signal for only the brightness signal output from the skin color correction device based on the output of the gamma correction control device;
a color space inverse transform device configured to transform the gamma-corrected brightness signal and the hue and saturation signals output from the skin color correction device to color signals as output data; and
a video display device configured to display the color signals as an image.

6. The video processing apparatus of claim 5, wherein
the skin color region detection device includes:
a hue-based skin color detector configured to detect the skin color based on only hue;
a saturation-based skin color detector configured to detect the skin color based on only saturation;
a brightness-based skin color detector configured to detect the skin color based on only brightness; and
a skin color region determiner configured to determine the skin color region based on the outputs of the hue-based, saturation-based, and brightness-based skin color detectors.

7. A video processing method comprising the steps of:
detecting a skin color region in one frame from hue, saturation, and brightness signals;
calculating the area of a skin color portion of one frame based on the skin color region detection result;
generating a gamma correction control signal for a luminance signal based on the output from the skin color area calculation step;
performing gamma correction according to the gamma correction control signal for the luminance signal as input data based on the output from the gamma correction control step;
transforming the gamma-corrected luminance signal and color-difference signals to the hue, saturation, and brightness signals;
correcting only the skin color based on the outputs from the skin color region detection step and the color space transform step;
transforming the corrected hue, saturation, and brightness signals output from the skin color correction step to color signals as output data; and
displaying the color signals as an image.

8. The video processing method of claim 7, wherein
the skin color region detection step includes:
a hue-based skin color detection step of detecting the skin color based on only hue;
a saturation-based skin color detection step of detecting the skin color based on only saturation;
a brightness-based skin color detection step of detecting the skin color based on only brightness; and
a skin color region determination step of determining the skin color region based on the outputs from the hue-based, saturation-based, and brightness-based skin color detection steps.

9. A video processing method comprising the steps of:
transforming color signals as input data to hue, saturation, and brightness signals;
detecting a skin color region in one frame from the hue, saturation, and brightness signals output from the color space transform step;
correcting only the skin color based on the hue, saturation, and brightness signals output from the color space transform step and the output from the skin color region detection step;
generating a gamma correction control signal based on the output from the skin color region detection step;
performing gamma correction according to the gamma correction control signal for only the brightness signal output from the skin color correction step based on the output from the gamma correction control step;
transforming the gamma-corrected brightness signal and the hue and saturation signals output from the skin color correction step to color signals as output data; and
displaying the color signals as an image.

10. The video processing method of claim 9, wherein
the skin color region detection step includes:
a hue-based skin color detection step of detecting the skin color based on only hue;
a saturation-based skin color detection step of detecting the skin color based on only saturation;
a brightness-based skin color detection step of detecting the skin color based on only brightness; and
a skin color region determination step of determining the skin color region based on the outputs from the hue-based, saturation-based, and brightness-based skin color detection steps.

11. A video processing method comprising the steps of:
transforming color signals as input data to hue, saturation, and brightness signals;
detecting a skin color region in one frame from the hue, saturation, and brightness signals output from the color space transform step;
recognizing the shape of a human based on the output from the skin color region detection step;
correcting only the skin color based on the hue, saturation, and brightness signals output from the color space transform step and the output from the object recognition step;
generating a gamma correction control signal based on the output from the object recognition step;
performing gamma correction according to the gamma correction control signal for only the brightness signal output from the skin color correction step based on the output from the gamma correction control step;
transforming the gamma-corrected brightness signal and the hue and saturation signals output from the skin color correction step to color signals as output data; and
displaying the color signals as an image.

12. The video processing method of claim 11, wherein
the skin color region detection step includes:
a hue-based skin color detection step of detecting the skin color based on only hue;
a saturation-based skin color detection step of detecting the skin color based on only saturation;
a brightness-based skin color detection step of detecting the skin color based on only brightness; and
a skin color region determination step of determining the skin color region based on the outputs from the hue-based, saturation-based, and brightness-based skin color detection steps.
